(19) United States
(12) Patent Application Publication
(10) Pub. No.: US 2009/0102804 A1
(43) Pub. Date: Apr. 23, 2009

(54) TOUCH-BASED APPARATUS AND METHOD THEREOF

(75) Inventors: SHIH-FANG WONG, Tu-Cheng (TW); XIN LU, Shenzhen (CN); YU-CUI ZHOU, Shenzhen (CN)

Correspondence Address: PCE INDUSTRY, INC.;ATT. Steven Reiss, 458 E. LAMBERT ROAD, FULLERTON, CA, 92835, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 11/967,095

(22) Filed: Dec. 29, 2007

(30) Foreign Application Priority Data
Oct. 17, 2007 (CN) 200710202107.4

(51) Int. Cl. G06F 3/041

(52) U.S. Cl. 345/173

(57) ABSTRACT

A touch-based apparatus includes a display screen, a sensitive screen, and a micro processing unit. The sensitive screen and the display screen are coupled to the micro processing unit. The display screen is used for displaying images or icons. The sensitive screen is used for detecting positional coordinate of the touched portion. The micro processing unit is used for calculating an area of the touched portion according to the positional coordinate, and adjusting a display ratio of the images and icons based on the calculated areas.

### BACKGROUND

1. Field of the Invention

The present invention generally relates to touch-based apparatuses, and more particularly, relates to a touch-based apparatus and a method of performing zoom control for viewing images or icons.

2. Description of Related Art

Touch-based apparatus is a type of combined input/output apparatus and recently has been widely used in various electronic devices such as handsets, game machines, and so on. Generally, the touch-based apparatus includes a display screen and a sensitive screen superposed on the display screen. The sensitive screen is used for sensing touching inputs and producing electrical signals in response to the touching inputs. In response to the electrical signals, images are displayed on the display screen.

Conventionally, when an enlarged image is displayed on the display screen, scrollbars are often used to move left and right or up and down to view the whole image.

However, a display size of the display screen may be relatively small, and using scrollbars may be cumbersome and slow.

Therefore, what is desired in the industry is to provide a touch-based apparatus capable of performing zoom control for easily viewing the images.

### SUMMARY

Accordingly, a touch-based apparatus is provided for performing zoom control. In one embodiment, a display ratio is controlled based on an area of a touched portion of the touch-based apparatus. The touch-based apparatus includes a display screen, a sensitive screen, and a micro processing unit. The sensitive screen and the display screen are coupled to the micro processing unit. The display screen is used for displaying images or icons thereon. The sensitive screen is used for detecting positional coordinates of the touched portion. The micro processing unit is used for calculating an area of the touched portion according to the positional coordinates, and adjusting a display ratio of the images based on the calculated area of the touched portion. Moreover, a method for performing the zoom control is also provided.

Other advantages and novel features of the present invention will become more apparent from the following detailed description of preferred embodiment when taken in conjunction with the accompanying drawings.

### BRIEF DESCRIPTION OF THE DRAWINGS

FIG. 1 is a block diagram of a touch-based apparatus of an exemplary embodiment.

FIG. 2 is a flowchart of a method for performing zoom control of images displayed by the touch screen as illustrated in FIG. 1.

### DETAILED DESCRIPTION

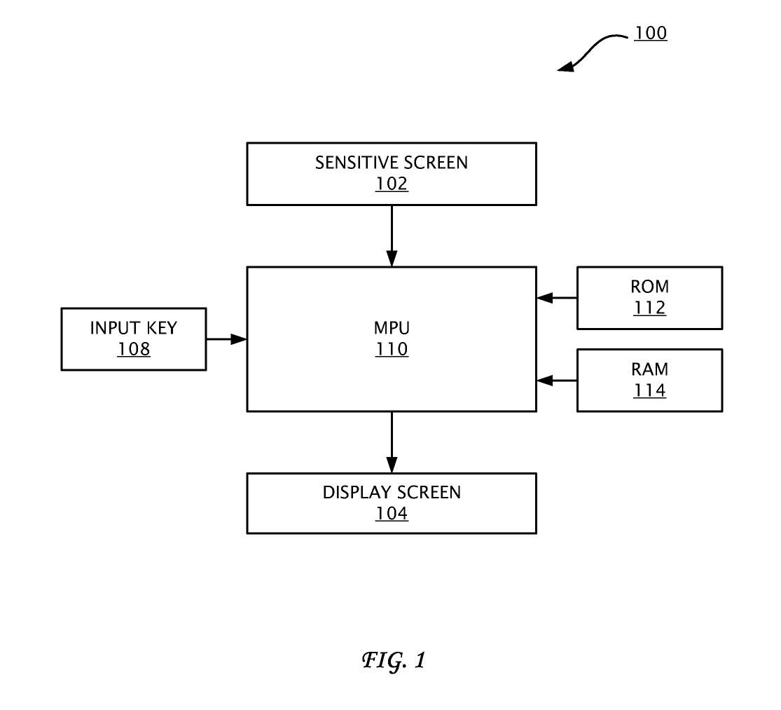

Referring to FIG. 1, a touch-based apparatus 100 is provided for performing zoom controls for images or icons. The touch-based apparatus 100 includes a sensitive screen 102, a display screen 104, a read only memory (ROM) 112, and a random access memory (RAM) 114 that are electrically coupled to a micro processing unit (MPU) 110 of the touch-based apparatus 100. The sensitive screen 102 is superposed on the display screen 104 to form a combined input/output apparatus.

The sensitive screen 100 can be touched by a touching object such as a finger or a stylus. The sensitive screen 100 is responsive to touching inputs at a touched portion of the sensitive screen 100. The sensitive screen 102 may be a capacitive type. When the sensitive screen 102 is touched, capacitance changes at the touched portion, and electrical signals representing (x, y) positional coordinates of the touched portion are sent to the MPU 110.

When the sensitive screen 102 is touched with a finger, an area of the touched portion varies. For example, a magnitude of the touching force exerted on the sensitive screen 102 and a direction of the touching force can affect the area of the touched portion. In the preferred embodiment a relationship is established between the area of the touched portion and a display ratio of the images or icons displayed on the display screen 104. When the area of the touched portion varies, the display ratio can also be vary accordingly. In other words, a dynamic zoom control can be implemented to control the display ratio of the images and the icons. For example, when the area of the touched portion increases, the images or the icons are zoomed in. When the area of the touched portion decreases, the images or the icons are zoomed out.

Furthermore, when the touching force exerted on the sensitive screen 102 is varied, the images or the icons also may be simultaneously zoomed in and out to increase sensitivity. For example, if the touching force is relatively high, the images or icons are enlarged. If the touching force is relatively low, the images or icons are shrunk.

More details regarding the relationship between the area of the touched portion and the display ratio, and the relationship between the touching force and the display ratio will be described below.

The original images or icons may be assigned to a predetermined display area S0 corresponding to predetermined pixel units P0. Parameters of the predetermined area S0 and the predetermined pixel units P0 may be stored in the ROM 112. The area S1 of the touched portion may be calculated by the MPU 110 as below.

In a first method, (x, y) positional coordinates of the touched portion is obtained by the sensitive screen 102. A circle function expressed as (x−h)²+(y−k)²=r² is used to describe the touched portion, wherein the coordinate (h, k) indicates a center point of the touched portion, the parameter r represents an approximate radius of the touched portion. Thereby, the area S1 of the touched portion can be expressed as S1=πr².

Alternatively, the touched portion may be described by an ellipse function expressed as (x−h)²/a²+(y−k)²/b²=1, wherein coordinate (h, k) indicates a center point of the touched portion, parameter a and b represents a half of a long axis and a short axis respectively. Thereby, the area S1 of the touched portion can be expressed as S1=πab.

In a second method, the area S1 of the touched portion can be calculated by counting an amount of pixels of the touched portion. Assuming that the touched portion has N1 pixels, and one pixel unit has a predetermined area of P0′. Then the area S1 of the touched portion can be expressed as S1=N1*P0′.

After the area S1 of the touched portion is calculated, a coefficient R, expressed as R=S0/S1 can be derived. If S1 is larger than S0, R is less than 1. If S1 is smaller than S0, R is greater than 1. Therefore, in order to enlarge the images or icons, the display area S0 of the original images or icons is multiplied by the coefficient R greater than 1. Similarly, in order to shrink the images or icons, the area S0 of the original images or icons may be multiplied by the coefficient R less than 1. It should be noted that the display ratio can be adjusted by multiplying a constant number α to the coefficient R.

Simultaneously, the sensitive screen 102 may also perform the dynamic zoom controls according to the touching force. Lists of a touching force range corresponding to a display ratio are preconfigured in a table stored in the ROM 112. For example, a first touching force range f1˜f2 corresponds a display ratio of z1 and a second touching force range f2˜f3 corresponds to a display ratio of z2. If the sensitive screen 102 is touched by a force with a range g between f1 and f2, the images or the icons are enlarged by a display ratio of z1.

The touch-based apparatus 100 may further include an input key 108. The input key 108 is electrically connected to the MPU 110. The input key 108 may be pushed or released to enable or disable the zoom control of touch-based apparatus 100. Alternatively, the zoom control can be enabled or disabled upon software controls. For example, a dialogue box may pop up and used for selecting a “YES” icon or a “NO” icon to enable or disable the zoom control. When the zoom control are disabled by the input key 108, the touch-based apparatus 100 may resume to a default state where the images are displayed at a default display ratio.

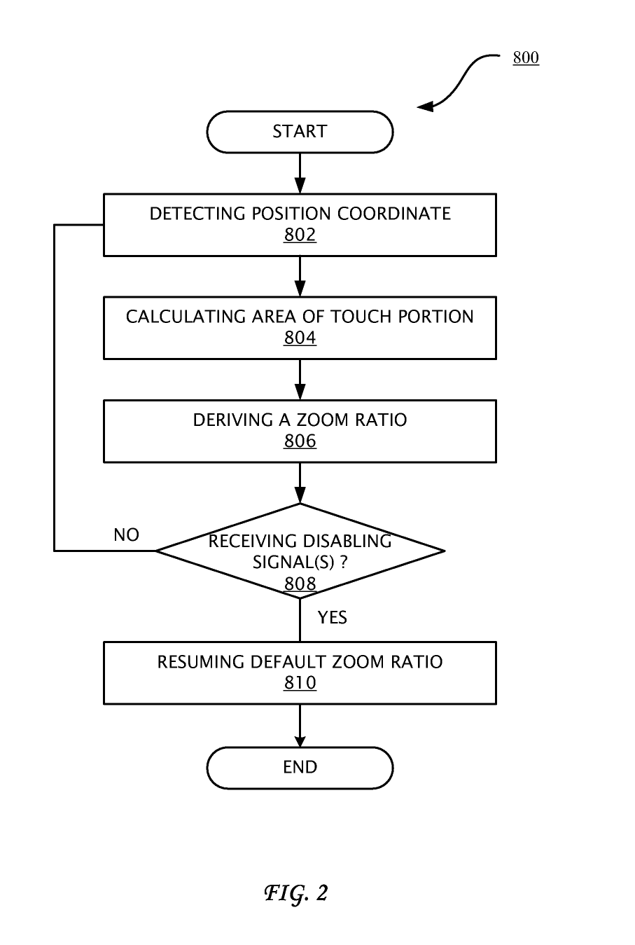

Referring to FIG. 2, a method 800 for performing zoom control will be described hereinafter. In some embodiments, the method 800, or portions thereof, may be performed by the touch-based apparatus 100 as described above, although the method 800 is not limited by the particular type of apparatus, software element, or system performing the method. The various actions in the method 800 may be performed in the order presented, or may be performed in a different order. Further, in some embodiments, some actions listed in FIG. 2 may be omitted from the method 800.

At block 802, positional coordinates are detected. For example, a touched portion of the sensitive screen 102 is touched. The positional coordinates of the touched portion may be detected by capacitance means. The capacitance means uses capacitors for sensing touching forces exerted thereto, thereby electrical signals are produced.

At block 804, the area of the touched portion is calculated. For example, the touched portion may be described by a circle or an ellipse. Therefore, an area S1 of the touched portion can be calculated by expressions of S1=πr² or S1=πab. Alternatively, the area S1 of the touched portion can be calculated by counting the pixel numbers.

At block 806, a display ratio is derived. For example, the area S0 of the original images or icons may be multiplied by a coefficient R expressed as R=S0/S1. As the area S1 of the touched portion is determined the display ratio can be changed correspondingly.

At block 808, an action is implemented for determining if a disabling signal is received. The disabling signal may be inputted by pushing a key arranged at a side portion of the touch-based apparatus 100 or selecting an icon displayed on the display screen 104.

At block 808, if a disabling signal is received, the images to be displayed are resumed to a default display ratio. After that, the control procedure goes to end directly.

At block 810, the control procedure loops back to the block 802, where the positional coordinates are detected again.

As the embodiment of the touch-based apparatus 100 and method 800 thereof described. The area of the touched portion is varied, such that a zoom control is achieved by associating it to the area of the touched portion at the sensitive screen 102. Moreover, the touching force exerted on the sensitive screen 102 may be utilized to change the display ratio, by which a dynamic zoom control can be realized. The user may view the images or icons on the display screen 104 more easily.

Alternative embodiments will become apparent to those skilled in the art to which the present invention pertains without departing from its spirit and scope.

What is claimed is:

1. A touch-based apparatus, comprising:
a display screen for displaying images thereon;
a sensitive screen sensing touching inputs at a touched portion of the sensitive screen to produce electrical signals representing positional coordinates of the touched portion in response to the touching inputs; and
a micro processing unit coupled with the display screen and the sensitive screen, the micro processing unit calculating an area of the touched portion according to the electrical signals, and deriving a display ratio of the images corresponding to the calculated areas of the touched portion.

2. The touch-based apparatus described in claim 1, wherein the sensitive screen is superposed on the display screen.

3. The touch-based apparatus as described in claim 1, wherein the touching inputs are inputted by a finger of a user.

4. The touch-based apparatus as described in claim 1, wherein the touching inputs are inputted by a stylus.

5. The touch-based apparatus as described in claim 1, wherein the display ratio of the images are controlled by touching force exerted on the sensitive screen.

6. The touch-based apparatus as described in claim 5, wherein the display ratio is associated with a touching force range.

7. The touch-based apparatus as described in claim 1, wherein the touch-based apparatus further comprises an input key, the input key is pushed or released to enable or disable controlling the display ratio based on the calculated area of the touched portion.

8. The touch-based apparatus as described in claim 1, wherein the area of the touched portion is calculated by describing the touched portion as a circle.

9. The touch-based apparatus as described in claim 1, wherein the area of the touched portion is calculated by describing the touched portion as an ellipse.

10. The touch-based apparatus as described in claim 1, wherein the area of the touched portion is calculated by counting pixel numbers of the touched portion.

11. A method for performing zoom control to images of a touch-based apparatus, the touch-based apparatus comprising a sensitive screen and a display screen, the method comprising:
detecting positional coordinates of a touched portion;
calculating an area of the touched portion based on the positional coordinates; and
deriving a display ratio of the images or icons based on the calculated area of the touched portion.

12. The method as described in claim 11, further comprising:
receiving a signal for determining whether enabling or disabling the zoom control of the images.

13. The method as described in claim 11, further comprising:
resuming the images to a default display ratio if the zoom control is disabled.

14. The method as described in claim 11, further comprising:
detecting touching force exerted on the sensitive screen; and
calculating the display ratio of the images or icons based on the area of the touched portion and the touching force exerted thereto simultaneously.

15. The method as described in claim 11, wherein the action of calculating an area of the touched portion is implemented by describing the touched portion as a circle.

16. The method as described in claim 11, wherein the action of calculating an area of the touched portion is implemented by describing the touched portion as an ellipse.

17. The method as described in claim 11, wherein the action of calculating an area of the touched portion is implemented by counting pixel numbers of the touched portion.

18. A method for performing zoom control to images of a touch-based apparatus, the touch-based apparatus comprising a sensitive screen and a display screen, the method comprising:
detecting a touching force exerted on the sensitive screen;
calculating a display ratio based on the touching force; and
enlarging the images with the display ratio.

19. The method as described in claim 18, further comprising:
detecting positional coordinates of a touched portion;
calculating an area of the touched portion based on the positional coordinates; and
adjusting the display ratio based on the calculated area of the touched portion.
